(19) United States
(12) Patent Application Publication
(10) Pub. No.: US 2006/0273184 A1
(43) Pub. Date: Dec. 7, 2006

(54) Air heating apparatus comprising a flame monitoring device

(75) Inventors: Michael Pöhner, Munich (DE); Martin Brehmer, Woggersin (DE); Andreas Damnitz, Neubrandenburg (DE); Arno Malchow, Neustrelitz (DE)

Correspondence Address: ROBERTS, MLOTKOWSKI & HOBBES, P. O. BOX 10064, MCLEAN, VA, 22102-8064, US

(73) Assignee: Webasto AG, Stockdorf (DE)

(21) Appl. No.: 10/553,033

(22) PCT Filed: Apr. 10, 2004
(86) PCT No.: PCT/DE04/00754

§ 371 Date: Jul. 25, 2006

(30) Foreign Application Priority Data
Apr. 9, 2003 (DE) 103 16 194.5

(51) Int. Cl. B60H 1/00

(52) U.S. Cl. 237/28

(57) ABSTRACT

An air heating apparatus (10) for a vehicle, having a burner (20), a heat exchanger (22), a device for monitoring a flame which burns inside the burner (20), and a mechanism (16) for conveying heating air through the heat exchanger (22). In order to be able to inexpensively meet stricter requirements for air heating apparatus regarding low emission of harmful substances, the flame monitoring device is based on a mechanism (18, 28, 30) which has been previously provided in the air heating apparatus (10) and is used for measuring the temperature of heating air that flows through the air heating apparatus (10).

### BACKGROUND OF THE INVENTION

1. Field of the Invention

The invention relates to an air heater for a vehicle with a burner and a heat exchanger located on it, a device for monitoring a flame burning in the burner, and a device for conveying heated air through the heat exchanger. The invention furthermore relates to a vehicle which is provided with such an air heater.

2. Description of Related Art

In vehicles such as passenger cars, trucks, campers or ships and aircraft, demands for comfort and satisfaction of the passengers of the vehicles are currently becoming more and more important. At the same time, the scales according to which environmental compatibility and pollutant emissions of vehicles are evaluated have become more strict.

With an air heater, comfort in a vehicle, especially during cold days and nights in fall, winter and spring, can be greatly improved. For example, with the air heater, air can be taken in from the vicinity of the vehicle, then heated by the air heater and then delivered as hot air to the interior of the vehicle.

German Patent Application DE 197 35 079 A1 discloses a fuel-driven heater, especially an air heater which is operated independently of the engine, for motor vehicles, in which a flame detection sensor is located in the exhaust path. The CO₂ emission of the exhaust is monitored, and optionally, limited by a bottom or dome temperature sensor and the exhaust gas temperature sensor.

German Patent Application DE 101 38 821 A1 discloses an air heater and a process for determining the hot air blowout temperature of an air heater in which the hot air blowout temperature is determined using the temperature measured by a temperature sensor by way of an equipment-specific temperature model.

German Patent Application DE 197 02 339 A1 discloses a flame monitor for a heater which is made as a glow element within the burner.

### SUMMARY OF THE INVENTION

The object of the invention is to devise a vehicle with an air heater with which reliable operation of the air heater is economically ensured and especially can be matched to increased demands for low pollutant emission.

This object is achieved in accordance with the invention with the initially named air heater for a motor vehicle in which the device for flame monitoring is made with a means for measuring the temperature of the hot air flowing through the air heater. The object is furthermore achieved with a vehicle which is provided with such an air heater in accordance with the invention.

According to the invention, for flame monitoring in an air heater, additional sensors or those provided especially for this purpose are not used, but rather existing means are used to monitor the flame.

This takes place by the temperature of the hot air flowing through the air heater being measured, and based on this measurement signal, the presence and proper formation of the flame in the burner of the air heater are deduced. For example, for certain operating states of the air heater, setpoint temperatures of the hot air are determined, and these setpoint values are compared with current measured values in actual operation of the air heater. When differences occur, this enables a conclusion regarding the quality of the flame.

With the flame monitoring as claimed in the invention, a conventional flame monitor, for example, the glow element known from German Patent Application DE 197 02 339 A1, can be eliminated. Flame monitoring in accordance with the invention can be implemented solely by corresponding adaptation of software of a control device of the air heater. The elimination of a flame monitor leads to a considerable reduction in the production costs of the air heater. Moreover, reliable and trouble-free flame monitoring is ensured, so that the air heater can be operated reliably, and furthermore, by a corresponding control with comparatively little pollution.

In one advantageous development of the invention, the means for measuring the temperature of the hot air flowing through the air heater is made with a first sensor for measuring the temperature of the hot air flowing out of the air heater. The temperature of the out-flowing hot air with a corresponding evaluation reflects the temperature conditions prevailing in the burner so that especially the presence or absence of a flame can be deduced.

In certain operating states, only the absolute value of the temperature of the outflowing hot air can be economically evaluated. The absolute value can, furthermore, be viewed advantageously in combination with other quantities, and accordingly, the quality of the flame in the burner can be deduced.

In addition, simple and moreover accurate monitoring of the flame in an air heater in accordance with the invention is possible by the means being able to evaluate the temperature gradient of the out-flowing hot air. Thus, for example, the temperature increase of the hot air in a certain time interval can be evaluated during the start of the air heater, and for example, flameout in a burner can be detected by comparison with a theoretical temperature increase.

In the monitoring of a flame according to the invention, the monitoring accuracy can be improved especially in that the means is made with a second sensor for measuring the temperature of the hot air flowing into the air heater. With this arrangement, in flame monitoring, those disruptive influences which are due to changes in the environment of the air heater can be taken into account. Thus, for example, a brief change in the outside temperature and the resulting cooling of the out-flowing hot air can be detected. In addition, with monitoring of the temperature of the in-flowing hot air, variables can also be considered which would otherwise be included in flame monitoring only at additional cost. For example, with continuing operation, the air heater heats up overall; this also affects the hot air flowing through the air heater. The heated air heater also heats up the inflowing air to a slightly greater degree so that the effect can be taken into account by measuring its temperature.

In order to ensure relatively accurate monitoring of the flame in an economical manner, it can be sufficient if the means can evaluate the absolute value of the temperature of the inflowing hot air.

Moreover, the quality of the monitoring can be raised by the means being able to evaluate the gradient of the temperature of the inflowing hot air.

In order to further minimize especially the effect of temperature fluctuations in the intake air and thus the supplied hot air of the air heater, the flame monitoring device can advantageously evaluate the difference of absolute values of the temperatures of the inflowing and outflowing hot air.

Alternatively or in addition, it is advantageous if the flame monitoring device can evaluate the difference of the gradients of the temperatures of the inflowing and the outflowing hot air.

So that, as explained above, an economical approach can be devised, it is advantageous if the sensor for measuring the temperature of the hot air flowing out of the air heater is an overheating sensor which is present anyway on the heat exchanger of the air heater.

Moreover, the sensor for measuring the temperature of the hot air flowing into the air heater can advantageously be a circuit board temperature sensor in the hot air intake channel of the air heater. With this sensor, the overall operating temperature of the air heater, and thus, also the temperature of the combustion air supplied to the air heater can be considered when combustion is being controlled.

One embodiment of the air heater in accordance with the invention is explained in detail below with reference to the accompanying drawings.

### BRIEF DESCRIPTION OF THE DRAWINGS

The sole FIGURE is a diagrammatic lengthwise side sectional view of an air heater in accordance with the invention.

### DETAILED DESCRIPTION OF THE INVENTION

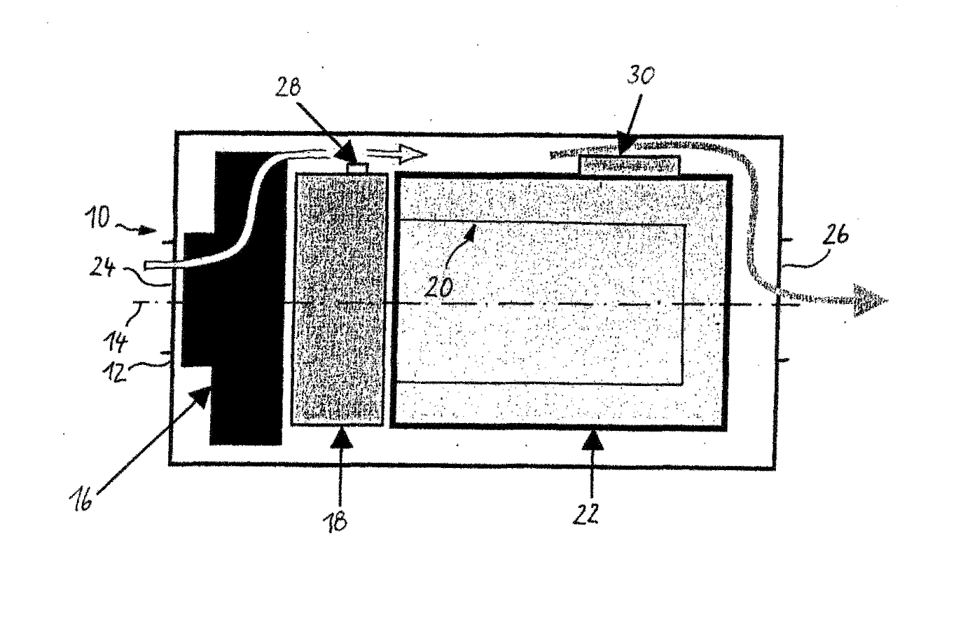

FIG. 1 shows an air heater 10 with an essentially cylindrical housing 12 that extends along an axis 14.

In the housing 12, proceeding from the left side of the FIGURE, there are, in succession, a hot air fan rotor 16, a control device 18 and a burner 20. The burner 20 is surrounded by a heat exchanger 22.

In operation of the air heater 10, the hot air fan rotor 16 delivers hot air through the housing 12. The hot air enters through a hot air inlet 24 on the front side of the housing 12 (left side in the FIGURE) and exits the housing 12 through a hot air outlet 26 (on the light front side in the FIGURE).

The flow path of the entering air through the housing 12 passes around the control device 18 and after which it is heated up by the heat exchanger 22.

On the control device 18, in the radially external edge area, there is a circuit board temperature sensor 28, by means of which the operating temperature of the circuit board of the control device, and moreover, also the absolute value and the gradient of the temperature of the entering air can be determined. Furthermore, in the air heater 10, on the radially external edge area of the heat exchanger 22, there is an overheating sensor 30 which is used, on the one hand, to detect the danger of overheating of the heat exchanger, and with which, on the other hand, the absolute value and the gradient of the temperature of the hot air emerging from the air heater 10 can be determined.

The circuit board temperature sensor 28 and the overheating sensor 30 are connected to the control device 18 by signal lines which are not shown. The control device 18 is, for its part, coupled in operation to the burner 20 so that it can control the supply of fuel and combustion air to the burner 20.

In order to devise especially economical and moreover exact monitoring of a flame which is burning in a burner 20, a device for flame monitoring is formed with the circuit board temperature sensor 28 and the overheating sensor 30. In this device, with the two sensors, the temperature of the hot air flowing through the air heater 10 is determined and the result of the determination is evaluated.

In the course of monitoring, the absolute value and the gradient of the temperature of the hot air flowing out of the air heater 10 are measured with the overheating sensor 30. Furthermore, the absolute value and the gradient of the hot air flowing into the air heater are measured with the circuit board temperature sensor 28.

The device for flame monitoring furthermore comprises a circuit (not shown) in the control device 18, and with which the difference of the absolute values of the temperatures of the in-flowing and out-flowing hot air is evaluated. Furthermore, the circuit can evaluate the difference of the gradients of the temperatures of the in-flowing and out-flowing hot air.

In the evaluation, the determined actual values are compared to the setpoint values which are filed in the form of tables in a memory of the control device 18. If deviations occur here, for example, flameout in the burner 20 can be recognized and the air heater 10 can be restarted accordingly.

Finally, it is noted that all of the features which are named in the application documents, are significant both individually and in any combination.

1. Air heater (10) for a vehicle with a burner (20) and a heat exchanger (22) located on it, a device for monitoring a flame burning in the burner (20), and a device (16) for conveying heated air through the heat exchanger (22), characterized in that the device for flame monitoring is made with a means (18, 28, 30) for measuring the temperature of the hot air flowing through the air heater (10).

2. Air heater as claimed in claim 1, wherein the means (18, 28, 30) is made with a first sensor (30) for measuring the temperature of the hot air flowing out of the air heater (10).

3. Air heater as claimed in claim 2, wherein the means (18, 28, 30) can evaluate the absolute value of the temperature of the outflowing hot air.

4. Air heater as claimed in claim 2 or 3, wherein the means (18, 28, 30) can evaluate the gradient of the temperature of the outflowing hot air.

5. Air heater as claimed in one of claims 2 to 4, wherein the means (18, 28, 30) is made with a second sensor (28) for measuring the temperature of the hot air flowing into the air heater (12).

6. Air heater as claimed in claim 5, wherein the means (18, 28, 30) can evaluate the absolute value of the temperature of the inflowing hot air.

7. Air heater as claimed in claim 5 or 6, wherein the means (18, 28, 30) can evaluate the gradient of the temperature of the inflowing hot air.

8. Air heater as claimed in one of claims 5 to 7, wherein the means (18, 28, 30) can evaluate the difference of the absolute values of the temperatures of the inflowing and outflowing hot air.

9. Air heater as claimed in one of claims 5 to 8, wherein the means (18, 28, 30) can evaluate the difference of the gradients of the temperatures of the inflowing and outflowing hot air.

10. Air heater as claimed in one of claims 2 to 9, wherein the sensor for measuring the temperature of the hot air flowing out of the air heater (10) is an overheating sensor (30) which is present anyway on the heat exchanger (22) of the air heater (10).

11. Air heater as claimed in one of claims 3 to 10, wherein the sensor for measuring the temperature of the hot air flowing into the air heater (10) is a circuit board temperature sensor (28) in the hot air intake channel of the air heater (10).

12. Motor vehicle with an air heater (10) as claimed in one of claims 1 to 11.
